(19) United States
(12) Patent Application Publication
(10) Pub. No.: US 2014/0298663 A1
(43) Pub. Date: Oct. 9, 2014

(54) Apparatus For Cutting Graphics

(71) Applicant: Gary A. Horgan, Waltham, MA (US)

(72) Inventor: Gary A. Horgan, Waltham, MA (US)

(21) Appl. No.: 13/859,067

(22) Filed: Apr. 9, 2013

(51) Int. Cl. B26B 25/00; B26B 29/06

(52) U.S. Cl. CPC B26B 25/007; B26B 29/06
USPC 30/292; 30/289

(57) ABSTRACT

Gap cutting apparatus and methods for slitting vehicle graphics are described. In one embodiment, the Gap cutting apparatus and methods are used to slit graphics for use with a vehicle and in particular when the graphics are disposed between body panels and the like. The gap cutting apparatus and methods are based upon three basic mechanical features and exploits these mechanical features in order to create a variety of tools and methods for quickly and accurately slitting graphics (and in particular vinyl-based sheeting graphics) and the like which span gaps between vehicle body panels and/or other gaps between other proximately disposed surfaces.

### CROSS REFERENCE TO RELATED APPLICATIONS

This application claims the benefit under 35 U.S.C. §119(e) of U.S. provisional patent application No. 61/686,584, filed on Apr. 9, 2012; U.S. provisional patent application No. 61/657,789, filed on Jun. 9, 2012; and U.S. provisional patent application No. 61/781,047, filed on Mar. 14, 2013, each of which are hereby incorporated herein by reference in their entireties.

### STATEMENT REGARDING FEDERALLY SPONSORED RESEARCH

Not Applicable.

### FIELD

The present concepts, apparatus and methods relate to the cutting or slitting of graphics including, but not limited to vehicle graphics and the like, more particularly, to quickly and accurately cutting or slitting graphics that bridge gaps between surfaces such as gaps between vehicle body panels and in addition to cutting other materials on a cutting mat or other suitable surface.

### BACKGROUND

As is known in the art, graphics are visual presentations on a surface of a material, such as a surface of a wall, canvas, screen, paper, or stone. Typically, the purpose of graphics are to brand, inform, illustrate, or entertain.

Graphics which are disposed on a vehicle (e.g. a car, truck, motorcycle, boat, plane, or other type of vehicle) are referred to as vehicle graphics. Such vehicle graphics have been used for everything from simple identification on a vehicle fender, to elaborate hand painted advertisements from bumper to bumper. And, with the Model-T, gone are the days of painstakingly hand lettered vehicles in the mainstream sign & lettering business. Nowadays vinyl lettering and graphics are the industry standard, either with computer cut individual colors, or digitally printed full sheets of adhesive backed vinyl with which the vehicle is wrapped.

Computer cut vinyl is what replaced hand painting, and such computer cut vinyl vehicle graphics are commonly found on many types of vehicles. Simple designs are cut from separate sheets of different colored vinyls, including some metalized vinyls as well, in order to create custom designs. This is a long and tedious process which can be a costly proposition as a design becomes more elaborate.

Digitally printed vinyl adhesive sheeting is currently revolutionizing the sign and lettering industry and is in the process of replacing the computer cut vinyl portion of the industry. Digitally printed vinyl is used on a lot of so-called “fleet vehicles” such as vans, busses and trucks having a common owner. It is permanently applied to a vehicle's body, and is known as a vehicle wrap, which is the wave of the future when it comes to vehicle lettering and graphics. One of the great things about vehicle wraps is that entire murals, photographs and lettering can completely or partially encompass a vehicle, turning it into a rolling billboard. There is even digitally printable vinyl that can be applied to back and rear side windows which can be seen through.

However, in either case, any time vinyl graphics (either computer cut vinyl or digitally printed vinyl adhesive sheeting) are applied to a vehicle and the material spans a gap (e.g. a gap between body panels or other surfaces of other objects on which the graphics will be disposed), the graphics material must often be cut or sliced along the gap. In the case of vehicles, for example, such cutting of the graphics material is necessary in order to avow for opening and/or closing of doors, hoods, trunks, gas cap access doors, etc. Furthermore, such cuts must be made accurately with respect to the edges of the panel(s) or other object edge(s) and must be made along the entire length of the graphics material because at least one free edge of the cut vinyl (or other graphics material) is typically is wrapped around edge(s) of the surface of the object on which the graphics is disposed (e.g. wrapped around edge(s) of the body panel(s), or the like).

Unfortunately, this is a very skill oriented task, and it is difficult to achieve an accurately true slice along the entire length of a given gap. The standard method of slicing vehicle graphics between gaps is by hand, using a modeling knife, or the like, typically resulting in a not so professional looking wrap along the edges of the panels or other objects. The problem is, there are very faint visual references as to exactly where the underlying panel edges are, and this becomes increasingly more difficult as graphic designs becomes more complex and more detailed with many obscure and detailed outlines, colors and gradients.

### SUMMARY OF THE INVENTION

The concepts, apparatus and methods described herein overcome the disadvantages of prior art apparatus and methods by combining three features in order to create a variety of tools and methods for quickly and accurately slitting vehicle graphics and the like between body panels and such.

When brought together, these features lend themselves to a variety of different embodiments, all of which afford a controlled and accurate slit of adhered sheeting between two parallel surfaces spaced by a gap (e.g. adjacent vehicle panel edges having a gap, or channel in between, which the gap cutting apparatus follows).

A first feature corresponds to a guiding structure comprising at least one conical, or wedge shaped section. At least a portion of the conical, or wedge shaped section of the guiding structure (e.g. a point or apex) is provided having a size and shape which allows insertion of the guiding structure into a gap between body panels until one or more angular surfaces of the guiding structure come in contact with the panel edges. The angular surfaces of the guiding structure are able to slide or roll along this channel while having its path remain parallel with the edges of the panels. The guiding structure may also include other guiding means.

A second feature corresponds to a slitting structure or at least one slitting means. In one embodiment, the at least one slitting means comprises a blade which acts in concert with, or is an integral part of the guiding structure (e.g. the wedge, or conical shaped component). The at least one slitting means which silts the spanned material as the guiding structure travels along the channel to guide the slitting structure. The combination of the first two features (i.e. the guiding structure and slitting structure) typically works best if the slitting structure physically precedes the guiding structure in a direction of travel such that the slitting structure opens the spanned material thereby enabling the guide(s) to freely drop down into the channel, while also pushing the slit material's free edges further down into the gap. However, the order and quantity of components are always optional, as particular applications, preferences, physical geometries or other dynamics may require alternate configurations.

A third feature or component is a control structure comprising at least one head section that supports the guiding and slitting structures or components. The control structure may also support other related components. The head section may be used as a handle and also as blade storage structure in some embodiments. And hi some embodiments, at least one portion of the head section corresponds to a handle. In addition, some embodiments of the handle can be designed for storage, and when combined with the head section, affords superior control of the guiding and slitting components.

In accordance with a further aspect of the concepts, devices and techniques described herein, a graphics cutting device for slitting graphics comprises a control structure; a guide structure, having a wedge-shaped profile in the form of one or more of a circular wedge structure; a linear wedge structure; or a conical shaped structure; and a slitting structure suitable for cutting graphics, said slitting structure having a cutting edge, said slitting structure mounted to at least one of said control structure or said guide structure.

In one embodiment, the control structure is integrally formed with one of: said slitting structure; or said guide structure.

In one embodiment, the guide structure is a first one of a plurality of guide structures.

In one embodiment, the guide structure comprises one or more wedge-shape surfaces.

In one embodiment, the wedge-shaped surface is provided as a circular wedge-shaped surface.

In one embodiment, the guide structure is provided as a circular, wedge-shaped guide structure corresponding to a surface of the graphics cutting device and integrally formed with said control structure; and the control structure is provided on a surface of said guide structure opposite the surface on which said guide structure is disposed.

In one embodiment, the control structure is provided having a cavity formed therein, the cavity having a size and shape selected to accommodate a slitting structure.

In one embodiment, the cavity is oriented such that a cutting edge of said slitting structure blade is positioned forward of said guiding structure.

In one embodiment, the guide structure is provided as a wedge shaped wheel.

In one embodiment, the slitting structure is provided as a wheel having a cutting edge provided around a circumference of said wheel.

In one embodiment, the guide structure and the cutting structure are integrally formed as a wheel coupled to said control structure, said wheel having a wedge shape and having a cutting edge provided around a circumference thereof wherein the cutting edge is suitable for cutting graphics.

In one embodiment, the device further includes axle pins coupled to the control structure and to a wedge shaped wheel such that the wedge shape wheel can freely rotate with respect to the control structure.

In one embodiment, the control structure is shelled and made of two removably coupled halves separated lengthwise from top to bottom and the guide structure axle pins are held in place when the graphics cutting device is assembled by axle bosses formed within the wheel reliefs thereby allowing said wedge shaped wheels to freely rotate.

In one embodiment, the guide structure is provided from a wheel having at least one chamfered sides, with a center bore that is designed to accept an axle, while allowing the wheel to freely rotate about the axle.

In one embodiment, the wheel is provided having a pair of symmetrical chamfered sides suitable for keeping cutting device centered in a gap between surfaces of adjacent objects.

In one embodiment, the wheel is provided having a first chamfered side and a second side having a shape which is not symmetric with respect to the first chamfered side such that the asymmetrical sides are suitable to provide an offset cutting structure in order to make an offset cut in a gap between surfaces of adjacent objects.

In one embodiment, the at least one chamfered side of the guide structure is provided having one of: a concave shape; or a convex shape around its circumference.

In one embodiment, the device further includes two guide wheels combined with a cutting structure in the form of a circular blade having an outer diameter which is larger than a diameter the guide wheel structures.

In one embodiment, the device further includes a pair of head sections, each head section provided at an opposing end of said control structure and each head section comprising a respective slitting structure such that the graphics cutting device is provided having a pair of slitting structures.

In one embodiment, each of the pair of slitting structures is provided as a cutting wheel assembly with a first one of the cutting wheel assemblies corresponding to a centering wheel and the other one of the cutting wheel assemblies corresponding to an offset wheel.

In one embodiment, the slitting structure is provided as a modeling knife blade which is removably or permanently imbedded into the guiding structure, and/or the control structure. In one embodiment, the modeling knife blade structure is provided such that the corners of the non-cutting end of the blade are rounded for easy insertion into a preformed cavity of a vehicle graphics slitting device

In one embodiment, the edges of the controlling and guiding means are rounded.

In one embodiment, the control structure is provided from a body having a generally cylindrical shape with a substantially flat surface formed in a circumferential surface thereof and a conical wedge-shaped guiding structure projects from a bottom surface of the control structure; and a handle projects from a top surface of the control structure.

In one embodiment, a conical wedge shaped guiding component is pointing downward, being the bottom of the device, and is formed integrally with an elongated means of control member which is formed on top of the guiding means extending vertically to what is the top of the device and having the same circular profile as the guiding means as viewed from the top of the device and being cylindrical in shape. A second cylinder is formed integrally overlapping and slightly shorter than the first cylinder having their axis parallel with each other and their tops even in height, where both voids along the sides are filled in tangent with the diameter of the two cylinders, creating flat side faces on both sides of the device, having a top view profile that would resemble a rectangle with the short squared ends being rounded and tangent with the longer flat side faces.

In one embodiment, shorter overlapping cylinder has a cylindrical cavity formed through its top face, down along its vertical axis which is designed to accommodate insertion of a modeling knife and blade, in that the knife and blade are removably able to be passed down through the relief opening located at the top of the device until the blade protrudes through a planer blade relief, and the collet of the modeling knife rests on the bottom of the cylindrical cavity and can go no further. Because the two cylinders overlap, the blade partially protrudes through the conical guiding structure which is preferred for optimal function.

In one embodiment, the device can be made of a rigid material, soft material, or any durometer material required for a particular application.

In one embodiment, modeling knife and blade are removably inserted into a cavity formed in the guiding structure, or control structure, or both.

In one embodiment, the preformed blade relief faces are planer and centered between the two side faces of the device. In one embodiment, the cylindrical cavity and blade relief are oriented in a manner that the cutting edge of the blade is positioned facing forward with respect to direction of travel. In one embodiment, the cylindrical cavity and blade relief are oriented in a manner that the cutting edge of the blade is positioned forward of the guiding structure. In one embodiment, edges of the guiding means are wider than the gaps for which it is designed. In one embodiment, the edges of the controlling and guiding means can be rounded in order to afford an ergonomic feel.

In one embodiment, a vehicle graphics slitting device includes a control structure lengthened past the rear of the device in order to accommodate at least one additional guiding means and cylinder which is placed in line with the blade and first guiding means.

In one embodiment, the device control structure includes a cylindrical cavity which houses a modeling knife handle. In one embodiment, the cylindrical cavity which houses a modeling knife handle is eliminated and the modeling knife blade is held in place via the guiding structure.

In one embodiment, a modeling knife blade is removably or permanently imbedded into the guiding structure, or control structure, or both. In one embodiment, the devices includes a preformed blade cavity having faces which are planer and centered with the two side faces of the device. In one embodiment, a nub can be formed on at least one inside face of the blade cavity which will engage the slot in the blade in order to keep the blade from falling out of the cavity. In one embodiment, the cavity is oriented in a manner that the cutting edge of the blade is positioned facing forward with respect to direction of travel. In one embodiment, the cavity is oriented in a manner that the cutting edge of the bade is positioned forward of the guiding structures.

In one embodiment, the device can be made of a rigid material, soft material, or any durometer material required for a particular application.

In one embodiment, the edges of the controlling and guiding means are rounded in order to afford an ergonomic feel.

In one embodiment, the control and guide structures are formed together as one structure, but is also shelled and made of two halves separated lengthwise from top to bottom and are joined and separated at will via any conventional means, such as but not limited to, snap-fit, mechanical fastener(s), or hinged with catch(es).

In one embodiment, both halves of the shelled control and guide structure have at least one structural rib, or other means of support for a cutting structure inside their shelled portion. In one embodiment, at least one outer shell and structural rib has a relief formed in its end face in order to accommodate a cutting structure. In one embodiment, at least one structural rib has an alignment nub formed in its end face in order to engage a slot in a cutting structure in order to align and hold the cutting structure in place when the device is assembled.

In one embodiment, wherein a mirrored structured rib, opposite the rib with said alignment nub, located in the opposing half of the guide and control structure, has an alignment nub relief so that when the two halves are joined any interference caused by the alignment nub is eliminated, in one embodiment, a cutting structure is seated on a cutting structure relief formed in the outer shell and structural rib edges, or other means of support, and is also engaged by an alignment nub passing through a slot in the cutting structure. In one embodiment, at least one structural rib forms a storage compartment for cutting structure storage.

In one embodiment, the conical guiding and cylinder structures are eliminated and replaced by wedge shaped wheels having axle pins on each side which are able to removably snap into preformed cavities located in the underside of the device, thus allowing said wedge shaped wheels to spin freely. In one embodiment, both halves of the shelled control structure have at least one structural rib, or other means of support, for a cutting structure, inside their shelled portion, in one embodiment, at least one outer shell and structural rib edge, or other means of support, has a relief formed in its end face in order to accommodate a cutting structure, in one embodiment, at least one structural rib, or other means of support, has an alignment nub formed in its end face in order to engage a slot in a cutting structure in order to align and hold the cutting structure in place when the device is assembled. In one embodiment, the device further includes a mirrored structural rib, or other means of support, opposite the rib, or other means of support, with the alignment nub, located in the opposing half of the guide and control structure, and the has an alignment nub relief so that when the two halves are joined, any interference caused by the alignment nub is eliminated.

In one embodiment, the cutting structure relief is formed in the outer shell and structural rib edges, or other means of support, and is also engaged by the alignment nub passing through its slot. In one embodiment, at least one structural rib has a relief formed into its end face for cutting structure storage.

In one embodiment, a guide structure is provided in the form of a wheel having a chamfered edge, with a center bore that is designed to accept an axle, while allowing the wheel to spin freely, but stay true on said axle.

In one embodiment, the chamfered wheel is used in matching symmetrical pairs in order to keep the cutting structure centered in the gap between adjacent objects.

In one embodiment, the chamfered wheel is typically used in non-matching asymmetrical pairs in order to create an offset cutting structure in order to make an offset cut in the gap between adjacent objects.

In one embodiment, the chamfered edge of the guide structure could alternately be a concave or convex fillet around its circumference, or any other shape or embossed or debossed pattern required for a particular application.

In one embodiment, two guide wheels are combined with a cutting structure in the form of a circular blade whose outer diameter is slightly larger than the guide wheel structures.

In one embodiment, a cutting structure is provided in the form of a circular blade whose outer diameter is slightly larger than, and has a center bore identical to, the guide wheel structures for which it is designed to work with.

In one embodiment, the cutting structure is provided as a cutting wheel assembly comprising two guide structures with their widest faces facing each other combined with a cutting structure sandwiched between them with the axis's of the two guide structures and cutting structure collinear.

In one embodiment, a vehicle graphics slitting device includes a cutting wheel assembly which is readily affixed via conventional means to a wire frame control structure comprising a head portion having an axle which is perpendicular to the handle portion which in turn holds the cutting wheel assembly in line with said handle portion of the control structure while allowing the cutting wheel assembly to spin freely. In one embodiment, the wire frame handle portion is cut short and pressed or formed into a secondary handle portion made of wood or plastic, or other suitable material.

In one embodiment, a cutting wheel assembly is readily affixed on a self-aligning shoulder axle which is snapped into a set of axle retainers which are in turn formed into the bottom of an ergonomically shaped rectangular handle structure allowing the cutting wheel assembly to spin freely, yet remain centered on the shoulder axle, and true to the axis of rotation. A relief is formed into the bottom of the handle in order to accommodate cutting wheel assembly. In one embodiment, the rectangular control structure could be sectional in order to store related parts such as blades, wheels and shoulder axles. In one embodiment, the axle retainers could alternatively be mounted at the end on an elongated handle portion, like a paint roller handle, made of wood or plastic, or other suitable material.

In one embodiment, a vehicle graphics slitting device includes a control structure in the form of a molded two piece assembly which is mechanically joined together via any conventional means comprising at least one head portion and a handle portion. In one embodiment, the at least one head portion of the control structure itself resembles a wedge of pie having a curved side and two intersecting linear sides, with its tip being rounded and located at the front end of the device. In one embodiment, the at least one head portion of the control structure is wide enough, and has a wide enough opening, in order to accommodate a pair of wheel guide structures, a circular cutting structure, and an axle structure. In one embodiment, the axle structure is passed through the center bores of said wheel guide structures and circular cutting structure, having each end of the axle structure seated into axle bosses located on the inside faces at the front of, and concentric with the rounded tip of, the head portion of the control structure, thus allowing the wheel guide structures and the circular cutting structure to spin freely.

In one embodiment, a handle portion is integrally formed to, and protruding from, the back curved edge of the head portion of the control structure. In one embodiment, structural ribbing may be incorporated into the control structure as needed. In one embodiment, the outer shell mating edges of the two halves of the control structure may utilize standard lip and lip relief features in order for them to align with each other. In one embodiment, the two halves of the control structure each have a boss centrally located on the inside faces of the handle portions which mirror each other's position and are used for joining the two halves together. In one embodiment, a first boss has a clearance hole which runs through its axis and the outer shell of the control structure half, which is countersunk if needed to accommodate a countersunk threaded fastener and a second boss on the mating control structure half has a threaded center hole, or threaded insert formed within, which is aligned with the bosses axis in order to accommodate a threaded fastener.

In one embodiment, a vehicle graphics slitting device includes at least one finger guard structure formed at a head portion of a control structure in order to help prevent fingers from sliding forward onto the circular blade structure. In one embodiment, the finger guard structure is a ridge integrally formed across and protruding from the upper and lower broad edges of the head portion of the control structure.

In one embodiment, grip treads can be selectively formed on the outer surface of the control structure. In one embodiment, the grip treads can be provided as one or more of an integral part of said control structure; some type of stick on grip; some type of over-molding grip, made of another material all of which are suitable for providing a more ergonomic comfort and traction while using the device.

In one embodiment, a vehicle graphics slitting device includes a storage portion integrally formed into a back end of a handle portion of the control structure which is large enough to accommodate circular guide structures and circular blade structures, while having a center post able to have multiple diameters, designed to pass through the stored components center bores, in order to keep them in place and organized.

In one embodiment, at least one eyelet structure can be integrally formed as part of the control structure and is typically located at the far end of the device, but can be located wherever a particular application requires.

In one embodiment, a graphics slitting device includes a second head portion formed integrally to the back end of the handle portion of the control structure, replacing the storage portion and eyelet structure and able to accommodate at least a second cutting wheel assembly and an axle structure, in one embodiment, a first head portion of the controlling structure is suitable to house and support a center cut wheel assembly and the second head portion of the controlling structure could house and support an offset cut wheel assembly thus affording quick access to both center and offset cutting structures without having to disassemble and reassemble the device in order to change circular guide structure types.

In one embodiment, a circular guide structure is configured to accept a shoulder axle having two separate diameters. In one embodiment, a center bore of the circular guide structure is replaced with two separate diameter bores which are made along the axis of rotation of the guide structure, thus creating a shoulder which conforms to the profile of a shoulder axle. In one embodiment, a smaller center bore, corresponding to the smaller diameter of the shoulder axle, is made completely through the circular guide structure, along the axis of rotation. In one embodiment, a larger counter bore, corresponding to the larger diameter of the shoulder axle, is made partially through the device, along the axis of rotation of the guide structure, starting the counter bore on its widest face such that a shoulder axle can removably fit into said bored holes, having the smaller diameter axle portion protruding out the opposite side of the circular guide structure, having the larger diameter portion seated in the counter bore portion of the hole, while allowing the wheel to spin freely. In one embodiment, a second circular guide structure is placed on the opposite end of the shoulder axle, where the shoulders of the axle are designed to keep the two circular guide structures slightly apart from each other, thus allowing a circular blade structure and a circular blade guard to rotate and move freely between them.

In one embodiment, a blade guard made of a thin rigid material whose outer diameter is designed to be slightly larger than the diameter of the blade for which it is designed to guard. In one embodiment, the blade guard has a keyway tab protruding from the left edge, having a “T” shaped keyway, rotated 90 degrees clockwise, designed to engage a “T” bar which is integrally formed at the front end of a blade guard shuttle. In one embodiment, wherein the “T” bar and “T” shaped keyway engagement are designed to lock together when pulled in opposite directions, but in contrast, will allow the blade guard to freely move side to side along the length of said “T” bar. In one embodiment, a slot is formed into the face of the blade guard designed to allow free movement of a shoulder axle along said slot which starts level with the shaped keyway and near the center of said blade guard, and extends away from said “T” shaped keyway, toward, but not through the opposite edge. In one embodiment, the “T” shaped relief can be substituted with any other suitable shape required for a particular application.

In one embodiment, the device includes a blade guard shuttle made of a rigid but somewhat flexible material which is designed to be able to maintain the blade guard in either a use or non-use position. In one embodiment, a blade guard shuttle is an elongated rectangular structure having a top wall, a bottom wall, two end was and a central vertical wall from end to end, and top to bottom. In one embodiment, a boss relief slot is formed in said central wall towards the rear of the device, thus allowing a boss to pass through and freely move within it. In one embodiment, said boss relief slot is used as a means to stop said blade guard shuttle at the correct forward and rear positions in order to avow the stop and safety locks to freely pop onto their respective ports. In one embodiment, a “T” bar is formed across the width of the outer face of the front end wall and centered between its top and bottom which is designed to engage a “T” shaped keyway in the circular blade guard. In one embodiment, the “T” bar shape can be substituted with any other suitable shape required for a particular application. In one embodiment, a positioning cantilever is formed or attached and centered at the rear being about half the width of the blade guard shuttle, extending from the back wall upward slightly and then turns 90 degrees toward the front of the device reaching about half of the blade guard shuttle's length, thus creating a horizontal space between the two. In one embodiment, a tab is formed along the upper surface and across the free end of the positioning cantilever, having a filled in “V” shape, thus creating a barb facing towards the rear and an angular front face. In one embodiment, a button riser is formed on the upper surface of the free end of the positioning cantilever, perpendicular to the “V” tab. In one embodiment, a positioning button is formed on top of the button riser, thus creating enough space between the bottom of the positioning button and top of the “V” tab in order for the wall thickness of a control housing to easily pass between them. In one embodiment, structural ribbing may be incorporated into the design as required for a particular application.

In one embodiment, a blade guard shuttle includes a safety lock cantilever. In one embodiment, a safety lock cantilever is formed or attached and centered at the rear being about half the width of the blade guard shuttle extending from the back wall downward slightly and then turns 90 degrees toward the front of the device reaching about half of the blade guard shuttle's length, thus creating a horizontal space between the two. In one embodiment, a safety lock button is formed along the lower surface of the free end of the positioning cantilever, while having a barb facing towards the rear and an upward angled front face. In one embodiment, structural ribbing may be incorporated into the design as required for a particular application.

In one embodiment, a graphics slitting device includes a blade guard structure, a blade guard shuttle structure, and other associated safety features incorporated into the device. In one embodiment, an inner squared off “U” shaped wall structure, turned 90 degrees clockwise in relation to the front of the control structure pointing to the right, is incorporated into the handle portion of the control structure, which terminates at the upper and lower outer was of the handle portion, and creates three horizontal channels comprising a larger main channel centrally located which occupies approximately 75% of the handle's length starting from the front, and two narrower channels, one directly above and one directly below the main channel. In one embodiment, the main channel, is designed to house the blade guard shuttle while allowing it to move forward and backward freely. A relief is cut away from inner wall structure in order to avow both the positioning and safety lock cantilevers to wrap around said inner wall structure to the smaller upper and lower channels respectively. In one embodiment, a riser slot is formed in the top edge, and close to the front end, of the handle portion of the control structure which is centered and runs parallel with the length of the handle portion which allows the button riser of the blade guard shuttle to move freely within the riser slot. In one embodiment, the device includes at least two position lock ports, which allow the positioning tab of the blade guard shuttle's positioning cantilever to occupy either port and hold the shuttle in position, are formed along the riser slot, having a first position lock port being located at the forward most end of the slot, and a second position lock port being located approximately mid-way of the slot. In one embodiment, the at least two position lock port's forward and rear inner faces are angled coplanar respectively with the mating angled faces of a “V” tab. In one embodiment, a safety lock port is formed in the bottom edge of the handle portion of the control structure, opposite the riser slot and position lock ports, which is also centered between the sides of the device, allowing the safety lock button of the blade guard shuttle's safety lock cantilever to occupy its opening while in the non-use position. In one embodiment, the safety lock port's forward and aft inner faces are angled coplanar respectively with the mating angled faces of a safety lock button of a blade guard shuttle's safety lock cantilever.

In one embodiment, a safety lock button well is formed on the inside face of the bottom edge of the handle portion of the control structure, opposite said riser slot and position lock ports, which is also centered between the sides of the device, allowing the safety lock button of the blade guard shuttle's safety lock cantilever to occupy its opening, thus reducing stress on the flexed safety lock cantilever while in the use position. In one embodiment, the safety lock button well's forward and aft inner faces are angled coplanar respectively with the mating angled faces of the safety lock button of the blade guard shuttle's safety lock cantilever. In one embodiment, a blade guard shuttle is located in the central main channel of the handle portion of said control structure, having both its cantilevers occupying their respective upper and lower channels while having their positioning tab and safety button located in their forward apertures, thus being the non-use position. In one embodiment, a blade guard structure's “T” keyway is engaged with a “T” bar of a blade guard shuttle.

In one embodiment, the blade guard structure is also placed between two circular guide wheel structures and a shoulder axle passes through its axle slot. In one embodiment, wherein when the vehicle graphics slitting device is fully assembled in the non-use position, and in order to change positions both the positioning button and safety lock are depressed inward, while the positioning button is also slid towards the rear of the unit until the positioning tab pops up into the rear position lock port and the safety lock button occupies the safety lock button well, thus rendering the device locked in the use position having a portion of the circular blade edge fully exposed.

In one embodiment, when the vehicle graphics slitting device is fully assembled in the use position, and in order to change positions, only the positioning button need be depressed inward, while also being slid forward until the positioning tab pops up into the forward position lock port and the safety lock button pops into the safety lock port, thus rendering the device locked in the non-use position having 100% of the circular blade edge guarded.

In one embodiment, a vehicle graphics slitting device includes at least one finger guard structure formed at a head portion of a control structure in order to help prevent fingers from sliding forward onto the circular blade structure. In one embodiment, the finger guard structure is a ridge integrally formed across and protruding from the upper and lower broad edges of the head portion of the control structure.

In one embodiment, a vehicle graphics slitting device includes two head sections, which can house two sets of; blade guard structure, blade guard shuttle structures; and other associated safety features, which may be incorporated into both ends of the device facing in opposite directions. In one embodiment, the handle portion is lengthened to accommodate the two section heads and blade guard structure, blade guard shuttle structures; and other associated safety features so as to be able to guard both cutting wheel assemblies individually. In one embodiment, a storage portion is integrally formed into the back end of the handle portion of the control structure which is large enough to accommodate circular guide structures and circular blade structures, while having a center post able to have multiple diameters, designed to pass through the stored components center bores, in order to keep them in place and organized. In one embodiment, the graphics slitting device includes at least one eyelet structure can be integrally formed as part of the control structure and is typically located at the far end of the device, but can be located wherever a particular application requires. In one embodiment, at least one finger guard structure is formed at the head portion of the control structure in order to help prevent fingers from sliding forward onto the circular blade structure. In one embodiment, the finger guard structure is a ridge integrally formed across and protruding from the upper and lower broad edges of the head portion of the control structure. In one embodiment, the graphics slitting device further includes grip treads selectively formed on the outer surface of the control structure, so as to affording more ergonomic comfort and traction while using the device. In one embodiment, the grip treads are provided as an integral part of said control structure. In one embodiment, the grip treads are provided as some type of stick on, or over-molding grip, made of another material.

In one embodiment, the device includes a safety cover, designed to cover and protect the cutting wheel assembly, which removably snaps onto the head portion of the control structure. In one embodiment, two “V” shaped flanges formed centrally on both sides of the cover are configured to mate with the “V” shaped tip of the head portion of a control structure. In one embodiment, barbed tabs are placed facing outward located at places on the outer face of the cover designed to engage inner lips of a control structure's head portion, thus holding the cover securely in place. In one embodiment, the sides of the cover are depressed near said barbed tabs causing them to be disengaged with said inner lips, thus permitting removal of said cover.

In one embodiment, a graphics slitting device comprises a safety cover, designed to slip over the control structures of any of the above-described graphics slitting devices so as to protect cutting structures. In one embodiment, the safety cover removably fits onto the control structure and held in place via any conventional means suitable.

### BRIEF DESCRIPTION OF THE DRAWINGS

The concepts, apparatus and methods described herein will be more fully understood from the following detailed description taken in conjunction with the accompanying drawings, in which:

FIG. 1 is a side view of one exemplary embodiment of a graphics slitting device having a blade removably inserted in a preformed cavity and which provides a level of control and accuracy which is improved over current graphics slitting devices and methods;

FIG. 2 is a front view of the graphics slitting device of FIG. 1 in conjunction with a cross-sectional view of an adhesive backed vehicle graphics sheet of vinyl, spanned across a gap between a random pair of vehicle body panels, which the device is shown cutting through;

FIG. 3 is a perspective view of the embodiment of the graphics slitting device of FIGS. 1 and 2, combined with a partial view of an automobile, and shown accurately slitting a section of vehicle wrap spanning across a vehicle's body panel and gas cap access door;

FIG. 4A is an angular view of another embodiment of a graphics slitting device incorporating a conical guiding structure, a modeling knife handle and blade, and a rounded control structure.

FIG. 4B is a cross-sectional view of the graphics slitting device in FIG. 4A.

FIG. 5A is an alternate embodiment of a graphics slitting device which is similar to that shown in FIGS. 4A and 4B, but which has a control structure which is lengthened past the rear of the device in order to accommodate at least one additional guiding means and cylinder which is placed in line with the blade and first guiding means.

FIG. 5B is a perspective view of the graphics slitting device in FIG. 5A being used to separate vehicle graphics, in a partial view, spanned between two body panels.

FIG. 6A is a perspective view of an alternate embodiment of a graphics slitting device having a means for independently holding a slitting structure (e.g. modeling knife blade) in place.

FIG. 6B is a perspective view of an alternate embodiment of the graphics slitting device in FIG. 6A, in which the device is hollow with internal ribbing and includes a means for independently holding a slitting structure (e.g. modeling knife blade) in place, and storage for spare blades.

FIG. 7A is a perspective view of a different version of the graphics slitting device of FIG. 6A, in which the conical guiding structures have been replaced with wedge shaped wheels having axle pins which are able to removably snap into preformed cavities located in the underside of the device, while also having a cavity designed to removably retain a modeling knife blade.

FIG. 7B is a perspective view of a different version of the graphics slitting device in FIG. 7A, in which the device is hollow with internal ribbing, the wheels are held in place by wheel bosses and are not snap-fit, a means for independently holding a cutting structure (e.g. a modeling knife blade) in place, and storage for spare blades.

FIG. 8 is a perspective view of a guiding wheel structure having a chamfered outer face and a center bore, and when combined wide face to wide face with an identical guiding wheel structure, the combination creates a wedge profile when viewed on edge.

FIG. 9 is a perspective view of a circular blade structure having a center bore and is typically place between two guiding wheel structures in order to create a cutting wheel assembly.

FIG. 10 is a front view of a centered cutting wheel assembly comprising two symmetrical guiding wheel structures and a circular blade structure, whereas the cutting wheel assembly is placed into a gap between two panels.

FIG. 11 is a front view of an offset cutting wheel assembly comprising two asymmetrical guiding wheel structures and a circular blade structure, whereas the offset cutting wheel assembly is placed into a gap between two panels.

FIG. 12 is a perspective view of an offset cutting wheel assembly comprising two asymmetrical guiding wheel structures and a circular blade structure, whereas the offset cutting wheel assembly is mounted onto a wire frame control structure.

FIG. 13 is a perspective view of an offset cutting wheel assembly comprising two asymmetrical guiding wheel structures and a circular blade structure, whereas the offset cutting wheel assembly is mounted onto a shoulder axle, which in turn is snap fitted into a set of axle supports of a palm held vehicle graphics slitting device.

FIG. 14A is a perspective view of another version of a graphics slitting device shown in a partial view, being used to separate vehicle graphics spanned between two body panels.

FIG. 14B is a perspective view of the graphics slitting device of FIG. 14A, shown in the use position with its blade guard retracted.

FIG. 14C is a perspective view of the vehicle graphics slitting device of FIG. 14B, shown inverted and in the non-use position with its blade guard extended and safety lock engaged.

FIG. 15 is a perspective view of the graphics slitting device of FIG. 14B, shown in the use position with its blade guard retracted and its protective cover in place. One half of the control structure is removed, in addition to its fastener, exposing internal components.

FIG. 16 is an exploded view of the graphics slitting device of FIG. 14B.

FIG. 17A is a side view of the graphics slitting device of FIG. 14B, shown in the non-use position where a control structure half and a guiding wheel structure have been removed in order to expose some of its internal components.

FIG. 17B is a side view of the graphics slitting device of FIG. 14B, shown in the use position and in which portions of a control structure and a guiding wheel structure have been removed in order to expose several internal components.

FIG. 18A is a side view of the graphics slitting device of FIG. 14B, shown with its protective cover securely attached.

FIG. 18B is sectional view taken across lines 18B-18B of FIG. 18A.

FIG. 18C is sectional view taken across ones 18C-18C of FIG. 18A.

FIG. 19A is a perspective view of a graphics slitting device having two cutting ends; and.

FIG. 19B is a side view of the graphics slitting device of FIG. 19A.

### DETAILED DESCRIPTION OF THE INVENTION

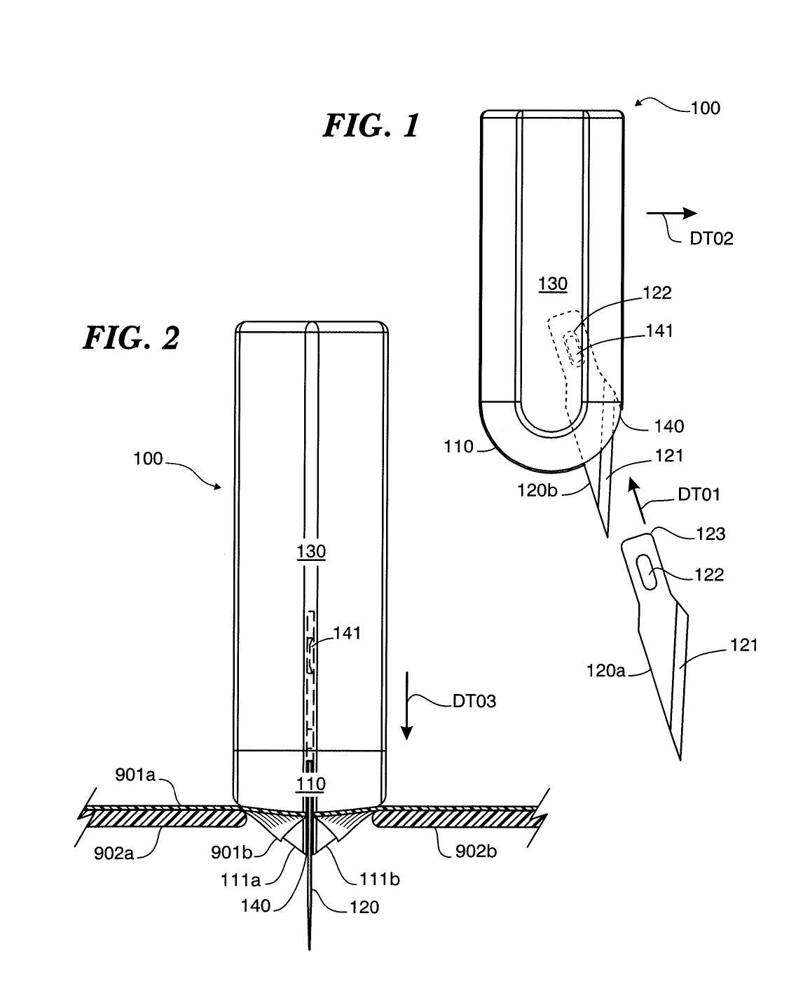

Referring now to FIGS. 1-3 in which like elements are provided having like reference designations throughout the several views, a manually controlled graphics slitting device 100 used to cut, or otherwise separate sections of vehicle graphics 901, or other materials, spanning across one or more gaps 907 between vehicle body panels 905, 906 includes at least three features as follows: a guiding structure; a slitting structure; and a control structure that supports the guiding and slitting structures. It should be appreciated that although reference is sometimes made herein to vehicle graphics disposed on vehicle body panels, the graphics slitting device 100 may be used to assist in the application of graphics to any object surfaces which are proximate each other but separated by a gap or a space. Thus, although graphics slitting device 100 is sometimes referred to herein as a vehicle graphics slitting device 100, it should be understood that graphics slitting device 100 finds use with graphics, or other materials, being applied to any type of objects.

Graphics slitting device 100 includes a guiding structure 110 located in the center of the device, just above the vinyl sheet in the form of a circular wedge shaped component which guides graphics slitting device 100 along channel 907 formed by a gap between body panels 905, 906 or other objects. In the exemplary embodiment of FIGS. 1-3 a wedge-shaped guiding structure having a circular or otherwise curved surface is shown. Graphics slitting device 100 includes a cutting structure 120. In one embodiment, the cutting structure 120 is provided as a blade which can be positioned approximately where shown. In this exemplary embodiment, the blade is provided as a planer blade having a cutting surface 121 and disposed in a preformed cavity 140. Preformed cavity 140 is provided having a shape and size selected to accommodate the outer surfaces of the portion of the blade. The blade can thus be inserted into cavity 140 and then moved in the direction of travel DT01. The blade is removably disposed inside said preformed cavity 140 to the position of blade 120b.

Graphics slitting device 100 further includes a control structure 130 which is integrally formed from the top of the guiding structure 110 and extends upward along a vertical axis (based upon drawing orientation), to a height consistent with optimal comfort and control (part of which, cavity 140 also occupies) Thus, cavity 140 extends up into part of structures 110, 130. The device's typical direction of travel while moving along a channel is represented by direction of travel DT02 (FIG. 2) and DTO4 (FIG. 3).

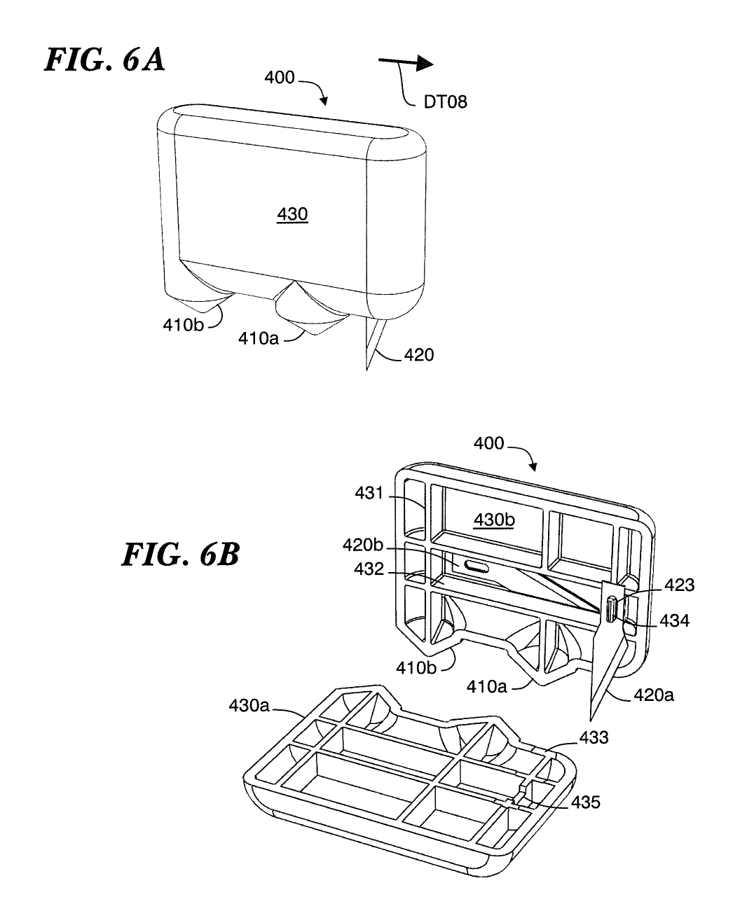

In the exemplary embodiment of FIG. 1, the guiding and control structures 110, 130 can be fabricated from a rigid material, a soft material, or any durometer, or type of material required for a particular application. The blades 120a,b can be fabricated of any suitable material such as, but not limited to, steel, tungsten, or ceramic and its two corners at the non-cutting end, or tang 123, can be rounded in order to facilitate ease of insertion into blade cavity 140. The blade cavity 140 and subsequently the inserted blade 120b, in this example, are at an oblique angle to the vertical axis of device 100 in order to position the cutting edge 121 of the blade 120b forward of the guiding means 110 in relation to the direction of travel DT02. However, the blade cavity 140 which conforms to the outer surfaces of the inserted portion of the modeling knife blade can be oriented in any position or location in order to conform to a particular design application. A nub 141 can be formed into at least one inside face of blade cavity 140 which would be positioned to engage the slot 122 located on both blades 120a,b when inserted, and will help hold blade 120b in place. For a visual reference of nub 141 see FIG. 6B, nub 434, however nub 141 would only protrude half to three quarters the thickness of blade 120a,b into the cavity. Other ways to keep the blade 120b in place would be to make the cavity a snug fit, or by using a pliable material where the act of lightly squeezing the sides of the device would be enough to keep the blade 120b in place, or in contrast, blade 120b can be permanently formed into components 110 and 130 during the molding process.

Alternately, the graphics slitting device 100 of FIG. 1 could be made of one solid, or hollow, piece of rigid material while embodying the three above-described features (i.e. a guiding structure, a cutting structure, and a control structure). This manually controlled vehicle graphics slitting devices 100 is just one of a variety of embodiments, some of which are explicitly disclosed herein and which serve to illustrate the concepts taught and claimed herein.

FIG. 2 is a front view of graphics slitting device 100 looking straight on at the sharp edge 121 of blade 120, combined with a sectional view of an adhesive backed vehicle graphics sheet of vinyl 901 with surface 901a, spanned across a gap between a pair of vehicle body panels 902a,b. In the exemplary embodiment of FIG. 2, the graphics slitting device 100 is shown cutting through vinyl sheet 901. In order to slit the vinyl sheet 901a, the device is held by its controlling means 130, and the blade 120, which is partially disposed inside slot 140, is manually centered over the gap between the panels 902a,b edges, and then pushed down through the vinyl sheeting 901a in the direction of travel DT03 and slightly forward in the direction of travel DT02 until the inclined faces 111a,b of the guiding structure 110 contact the vinyl covered edges of the panels 902a,b forming the gap. As the vehicle graphics slitting device is slid forward DT02, while keeping a constant pressure in direction DT03, the blade 120 slices through the vinyl sheeting 901a while just behind it, the guiding means 110 further separates and pushes the vinyl graphics sheeting 901b downward into the gap while helping to keep the blade 120 on track. A broad circular wedge shape is the ideal profile for this application because the shape is extremely versatile, in that it allows the vehicle graphics slitting device to function perfectly within a wide range of gap spans from very narrow, to just under the width of the guiding structure 110 of the vehicle graphics slitting device 100. It should be understood that because the inclined profile edges 111a,b of 110 creating a wedge are shown as linear, this does not limit them to this particular configuration. The term wedge, for purposes of this disclosure, simply refers to a shape that starts out wide and comes to a point, rounded tip, or any shape tip that is considerably narrower than its widest most dimension. The guiding structure 110 is designed to be wider than the widest typical gap between body panels 902a,b, or other objects. Therefore, these inclined straight edges 111a,b can also be curved in a concave or convex fashion, or stair stepped, or ribbed either concentric with its central axis and/or radiating outwardly from said axis, or any other shape or pattern embossed or debossed, required for a particular application. Additionally, the shapes of the opposing inclined edges 111a,b of circular wedge 110 can be designed either symmetrical or asymmetrical with each other, as required for a particular application.

While the guide structure 110 is designed to keep the device 100 substantially parallel with panel 902a,b edges, a certain degree of manual dexterity must also be incorporated into the effort in order to stay on track and achieve a precise slit the entire length of the channel. This is because there is only one guiding structure 110 which is great for initially centering the blade 120, but not for keeping it slitting parallel with the panel edges 902a,b as it moves forward. However, because this embodiment does not track very well, this makes it ideal for tight curves such as around gas cap access doors, as well as rounded door and panel corners. Alternately, the vehicle graphics slitting device 100 could also be configured to accept a rounded blade, or any other blade, that projects slightly past the perimeter of the circular wedge 110, which could replace the modeling knife blade 120.

FIG. 3 demonstrates, using a partial view of a vehicle, how the embodiment of the present invention 100 in FIGS. 1 and 2 might be used to slit adhered vinyl graphics sheeting 901 which is shown bridging a vehicle's body panel 905 and a gas cap access door 906, having their edges located under the vinyl sheeting 901 represented by thin dashed and dotted ghost outlines. The hidden portions of the vinyl graphics slitter 100 are represented by a set of heavier dashed lines 100a. In this example, the slit 903 was started near the finger well relief 904 of the body panel 905. The vinyl graphics slitter 100 is then rotated around the access door in a clockwise direction DT04, but either direction will work as long as the device is oriented properly, and would continue up to the start of the cut being careful not to get off track at the end because of the finger well relief 904. Alternately, the very last part of the cut could be completed with a modeling knife which would be a relatively simple task to perform. Once the cut is complete, the vinyl is then wrapped around the edges of the body panel 905 and access door 908 and pushed down into the finger well 904 for a finished professional look.

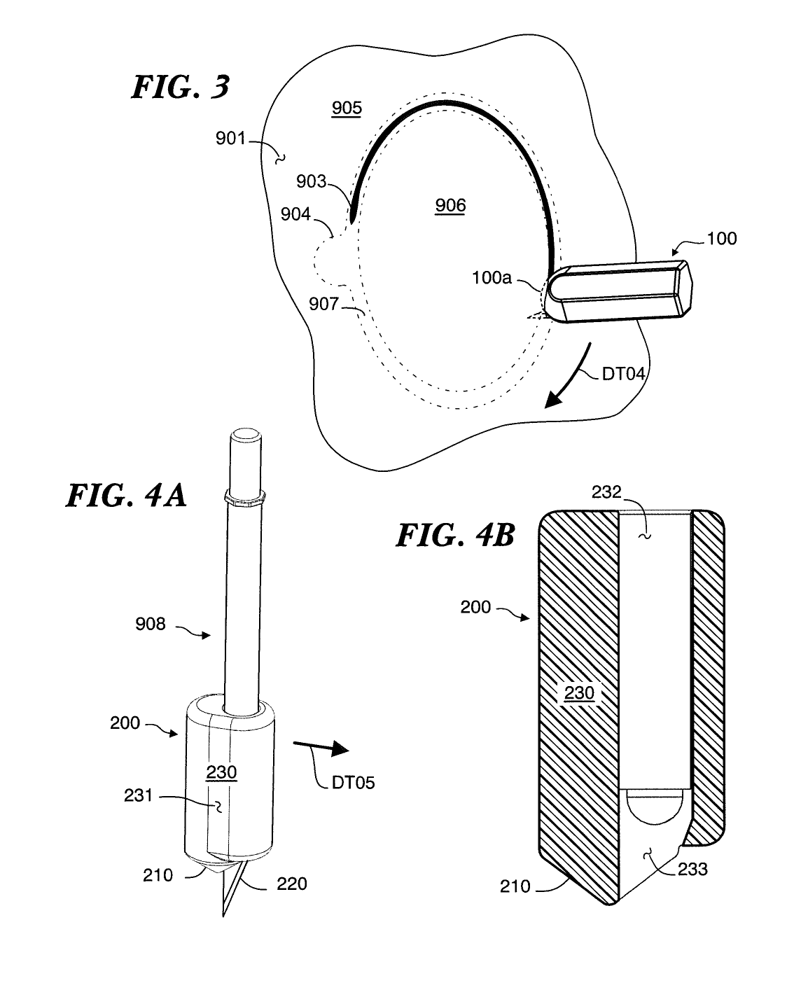

Referring now to FIGS. 4A and 4B in which like elements are provided having like reference designations throughout the two views, a manually controlled graphics slitting device 200 includes the three features described above in conjunction with the exemplary embodiment of FIGS. 1-3, but also employs the added control of a modeling knife handle 908. Furthermore, two of those features are different, in that the circular wedge shape guiding structure is replaced with a conical guiding structure 210, the control structure 230 is now an overlapping twin cylindrical shape in that both cylinders are level at the top of the device as oriented on the page, and both voids along the sides are filled in tangent with the diameter of the cylinders, creating flat side faces 231 on both sides of device 200. A top view profile would resemble a rectangle with the short squared ends being rounded and tangent with the longer flat side faces. One cylinder which is slightly the longer of the two, is formed integrally on top of the conical guiding structure which is pointing downward, while the shorter overlapping cylinder has a cylindrical relief 232 formed through its top face, down along its vertical axis which is designed to accommodate insertion of a modeling knife 908 and blade 220, in that the knife 220 and blade 908 are removably able to be passed down through the relief opening 232 located at the top of the device until the blade 220 protrudes through a planer blade relief 233, and the collet of the modeling knife rests on the bottom of the cylindrical relief 232 and can go no further. Because the two cylinders overlap, the blade 220 partially protrudes through the conical guiding structure 210 which is preferred for optimal function. The graphics slitting device 200 is manually moved in direction of travel DT05 and is used for tight radius turns such as in FIG. 3.

While circular cylinders are used to form the controlling structure 230, other shapes, including but not limited to square or rectangular extrusions may also be used and where the conical guiding structure 210 is replaced by a four sided chamfered wedge shaped guiding structure, or a circular or straight edge wedge. It should be appreciated that while a modeling knife 908 is used herein, the present embodiment of the graphics slitting device 200 can be designed to accommodate any type knife for a particular application. Sharp edges of the control and guide structures could be rounded in order to provide an ergonomic feel and smooth operation.

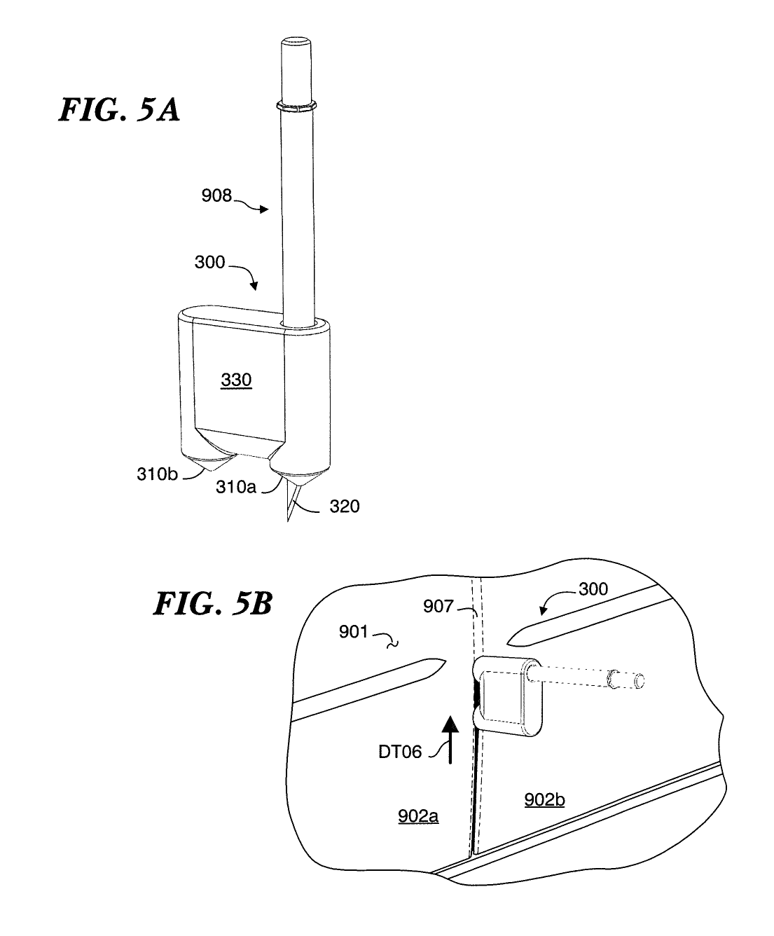

Referring now to FIGS. 5A and 5B in which like elements are provided having like reference designations throughout the two views, another embodiment of the manually controlled graphics slitting device 300 includes all of the mechanical features discussed in graphics slitting device 200 in FIGS. 4A & 4B, but also includes a second guiding structure 310b in addition to the first guiding structure 310a and a larger means of control structure 330. The second guiding structure 310b helps keep the blade relatively parallel with the gap edges between body panels 902a,b, and is well-suited for straight and slightly curved channels. FIG. 6B illustrates how the graphics slitting device 300, while being moved in direction of travel DT06, using the control structure 330 and the knife handle 908, would be used to slit vinyl sheeting 901 spanned across the gap 907 between vehicle body panels 902a,b. The slit vinyl 903 is pictured in the wake of the devices path.

Referring now to FIGS. 6A and 6B in which like elements are provided having like reference designations throughout the two views, another embodiment of the manually controlled graphics slitting device 400 includes all of the features discussed in graphics slitting device 300 in FIGS. 5A & 5B such as guiding structures 410a,b, a cutting structure 420 and a larger control structure 430, but eliminates the need for a knife handle. The graphics slitting device 400 in this exemplary embodiment can be designed as a single unit (as illustrated in FIG. 6A), or in sections FIG. 6B, which are able to be joined and separated at will by any conventional means, such as but not limited to, snap-fit, mechanical fastener(s), or hinged with catch(es). If the device is solid, cutting structure 420 would be removably disposed into a predisposed cavity as in previous teachings herein, or if designed to be produced in two or more separable sections, the blade 420b can be fixed in place when the device is assembled. In FIG. 6B the cutting structure 420a is held in position on section 430b by means of an alignment nub 434 which passes through slot 423 of cutting structure 420a. Reliefs are formed in both halves of graphics slitting device 400 in order to accommodate the cutting structure 420a when the device is assembled. In addition, a nub relief 435 is formed into the structural ribbing 431 of section 430a in order to eliminate any interference between the structures during assembly. Structural ribbing 431 can also be used to create at least one storage compartment 432 in which spare blades 420b can be stored. Guiding structures 410a,b are shown at the bottom of halves 430a,b of graphics slitting device 400. The graphics slitting device 400 is used identically as graphics slitting device 300 in FIG. 5B, except the modeling handle has been eliminated and the control structure 430 alone is used to manually operate the device.

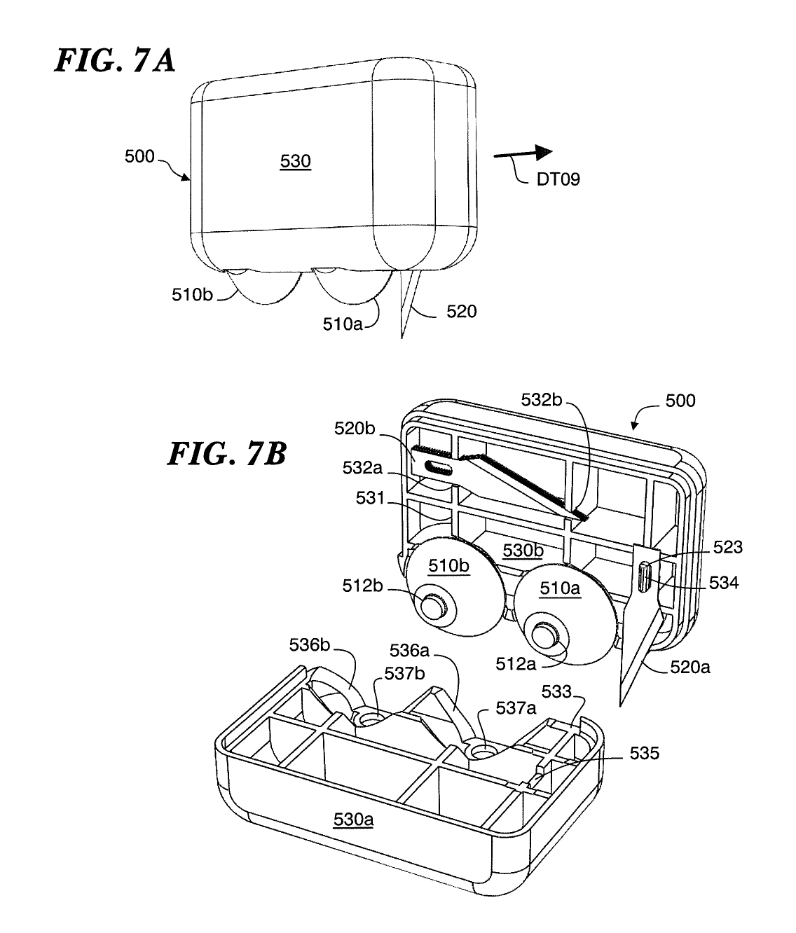

Referring now to FIGS. 7A and 7B in which like elements are provided having like reference designations throughout the two views, another embodiment of the manually controlled graphics slitting device 500 includes all of the mechanical features discussed in graphics slitting device 400 in FIGS. 6A & 6B such as a cutting structure 520 and a control structure 530, but in this design, the guiding structures are free spinning circular wedge shaped wheels 510a,b, thus greatly reducing drag and the possibility of distorting the very pliable vinyl graphics as the device is rolled along a gap between two objects.

In the exemplary embodiment of FIG. 7A, the graphics slitting device 500 could be made of a single section of rigid material and cutting structure 520 would be removably disposed into a preformed cavity as in previous teachings herein. The wedge shaped wheel guiding structures 510a,b can be removably snapped into place using commonly known snap-fit features, such as in plastic toys.

As shown in the exemplary embodiment of FIG. 7B the graphics slitting device 500 could be made in sections which are able to be joined and separated at will by any conventional means, such as but not limited to, snap-fit, hinged with catch(es) or, mechanical fastener(s) and the blade 520b can be removably secured in place when the device is assembled. In FIG. 7B, the cutting structure 520a is held in position on section 530b by means of an alignment nub 534 which passes through slot 523 of cutting structure 520a. Reliefs 533 are adjacently formed in both halves of graphics slitting device 500 in order to accommodate the cutting structure 520a when the device is assembled. In addition a nub relief 535 is formed into the structural ribbing 531 of section 530a in order to eliminate any interference between the structures during assembly. Reliefs 532a,b can be formed in the structural ribbing 531 which can be used to store spare blades 520b. Wheel reliefs 536a,b are adjacently formed into the two halves 530a,b of control structure 530, and within those wheel reliefs 536a,b, axle retainer bosses 537a,b are formed. When the graphics slitting device 500 is assembled, the axle pins 511a,b of free spinning circular wedge shaped wheels 510a,b are inserted into the axle retainer bosses 537a,b respectively. The graphics slitting device 500 is used identically as graphics slitting device 3001n FIG. 5B, except the modeling handle has been eliminated and the control structure 530 alone is used to manually operate the device.

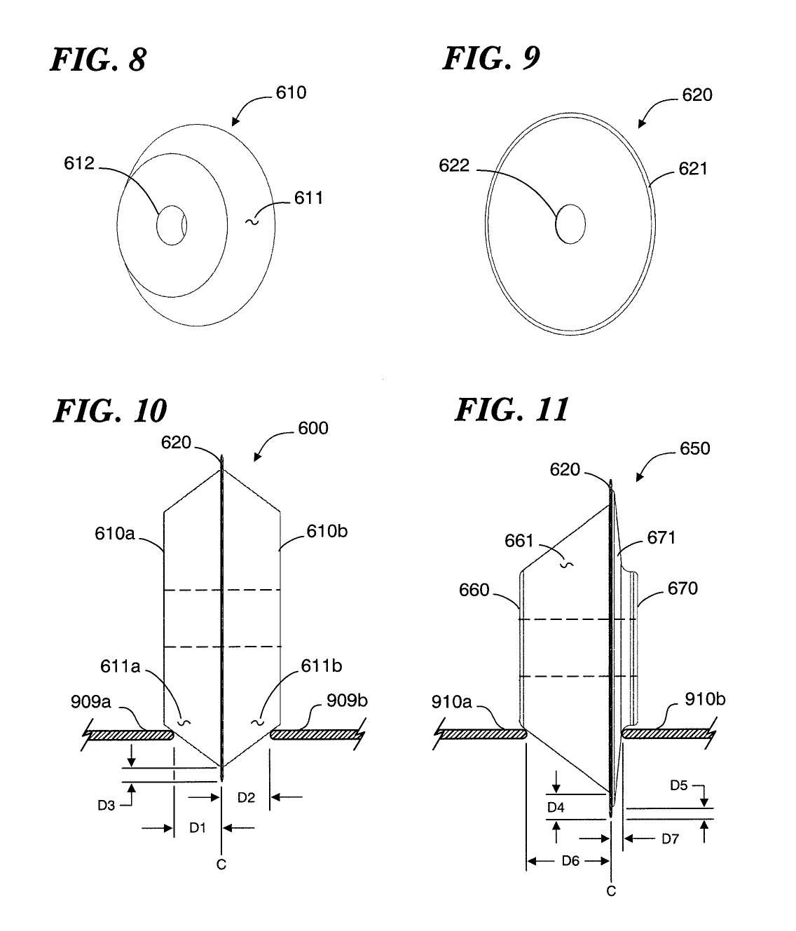

Referring now to FIGS. 8 through 11 in which like elements are provided having like reference designations throughout the two views, various embodiments of the guiding and cutting structures are described.

FIG. 8 is an illustration of a center cut wedge shaped wheel 610 having an inclined circular face, or chamfered edge 611, with a center bore 612, which is designed to accept an axle, while allowing the wheel 610 to spin freely, but true on said axle. The center cut wedge shaped wheel 610 is typically used in matching symmetrical pairs in order to keep the cutting structure centered in the gap between adjacent objects.

FIG. 9 is an illustration of a circular blade cutting structure 620 having a cutting razor edge 621 (e.g. a razor sharp edge 621), with a center bore 622, which is designed to accept an axle, while allowing the circular blade cutting structure 620 to spin freely on said axle, and is typically the same size bore as the wheels with which it will be used. The circular blade 620 can be fabricated of any suitable material such as but not limited to steel, tungsten, or ceramic.

FIG. 10 is a front view of a gap cutting wheel and circular blade assembly 600 comprising two center cut wedge shaped wheel structures 610a,b and a circular blade cutting structure 620, in conjunction with a cross-sectional view of a pair of vehicle body panels 909a,b, that create a gap in which the assembly 600 is seated in. The inclined opposing faces 611a,b of center cut wedge shaped wheels 610a,b are resting on the opposing edges of body panels 909a,b while keeping the circular blade cutting structure 620 centered, referenced by dimensions D1 and D2. The outer diameter of the circular blade cutting structure 620 is designed to be slightly larger than the outer diameter of the wedge shaped wheel structures 610a,b in order to slit any material ahead of said center cut wedge shaped wheel structures 610a,b before they part it and push it downward into the gap. An example of the contrast in diameters, is reflected in dimension D3 where the edge of the circular blade 620 is shown protruding past the edges of wedge shaped wheel structures 610a,b.

It should be understood that because the inclined profile edges 611a,b of wedge shaped wheel structures 610a,b creating a wedge are shown as linear, this does not limit them to this particular configuration. The term wedge, for purposes of this disclosure, simply refers to a shape that starts out wide and comes to a point, rounded tip, or any shape tip that is considerably narrower than its widest most dimension. The guiding structure is designed to be wider than the widest typical gap between body panels 908a,b, or other objects. Therefore, these inclined straight edges 611a,b can also be curved in a concave or convex fashion, or stair stepped, or ribbed either concentric with its central axis and/or radiating outwardly from said axis, or any other shape or pattern embossed or debossed, required for a particular application. Additionally, the shapes of the opposing inclined edges 611a,b of wedge shaped wheel structures 610a,b can be designed either symmetrical or asymmetrical with each other, as required for a particular application. While the centering wheels 610a,b and offset wheels 660 and 670 are shown as solid, they could alternately be shelled with internal structural ribbing and hubs.

FIG. 11 is a front view of an offset gap cutting wheel and circular blade assembly 650 consisting of two offset cut wedge shaped wheel structures 660 and 670, and a circular blade cutting structure 620, in conjunction with a cross-sectional view of a pair of vehicle body panels 910a,b that create a gap in which the assembly 650 is seated in. The inclined opposing faces 661 and 671 of offset cut wedge shaped wheels 660 and 670 are resting on the opposing edges of body panels 910a,b while keeping the circular blade cutting structure 620 offset, which is referenced by dimensions D6 and D7. The outer diameter of the circular blade cutting structure 620 is designed to be larger, preferably slightly larger, than the outer diameter of the wedge shaped wheel structures 660 and 670 in order to slit any material ahead of said wheel structures before they part it and push it downward into the gap. An example of the contrast in diameters, is reflected in dimensions D4 and D5 where the edge of the circular blade 620 is shown protruding past the edges of guide structures 660 and 670. Also in this configuration the outer diameter of offset guide structure 670 is closer to the edge of the circular blade 620 than the outer diameter of offset guide structure 660, also illustrated in dimensions D4 and D5. The reason for this is because the very thin wedge profile of offset guide structure 670 allows the cutting edge of the circular blade 620 to be in extremely close proximity to the edge of the objects creating the gap, which in turn, if not guarded, the circular blade 620 can cut into the edges of these objects as it moves along a gap. This is evident in a comparison of dimensions D6 and D7.

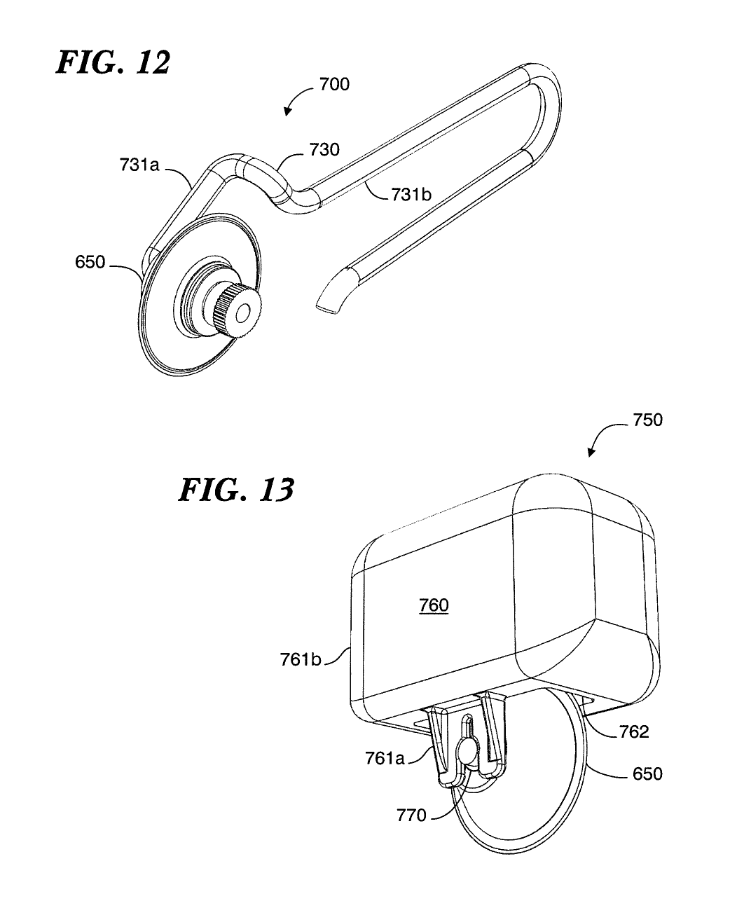

Referring now to FIGS. 12 and 13 in which like elements are provided having like reference designations throughout the two views, various control means of the guiding and cutting structures are described.

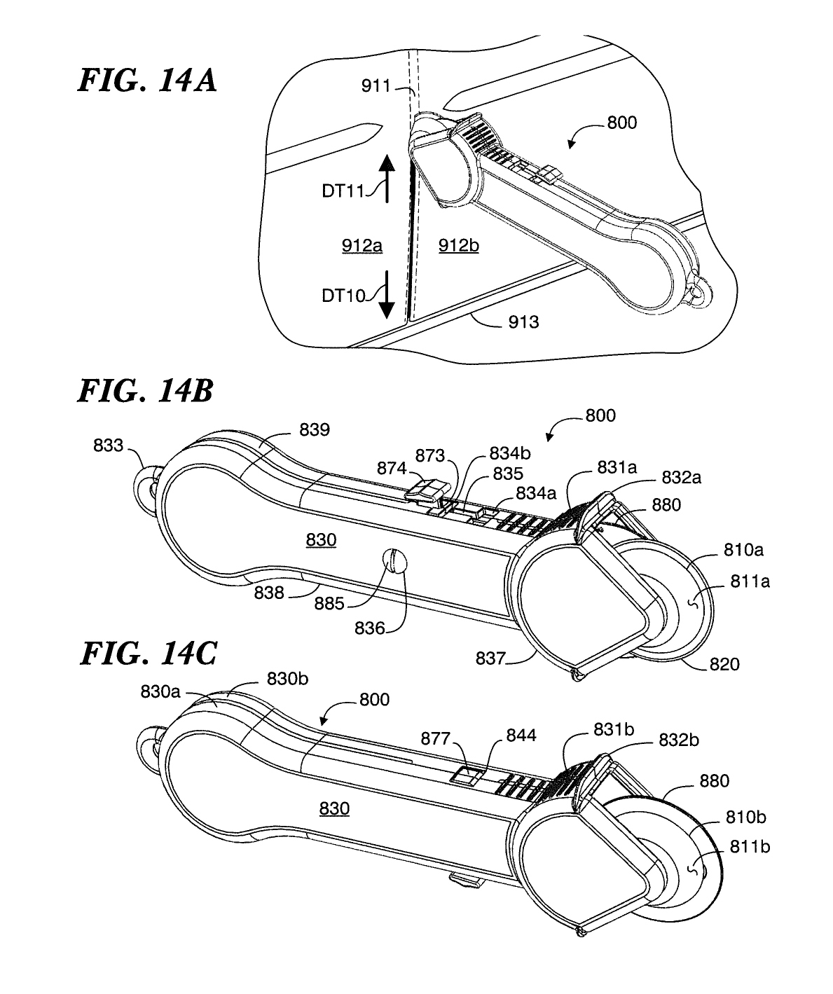

FIG. 12 illustrates how a graphics slitting device 700 of the present invention is created by incorporating the offset cutting wheel assembly 650 with a simple wire frame design as a means of control 730 in which a first portion serves as the head 731a and a second portion serves as a handle 731b. The offset cutting wheel assembly 650 would be mounted to the wire frame head portion 731a via any commonly known method which would allow the assembly 650 components to spin freely, yet remain close together, planer with the handle, and true to the axis of rotation. It should be understood, that while the offset cutting wheel assembly 650 is used in this example, any cutting wheel assembly, such as center cutting wheel assembly 600 in FIG. 10, could be used in its place. Graphics slitting device 700 is suitable for use with gaps and channels which create straight paths and relaxed curves. An example of the type of application this graphics slitting device 700 might be used, see FIG. 14A which demonstrates the use of an advanced version of a graphics slitting device 800.

Whereas FIG. 13 illustrates how a graphics slitting device 750 of the present invention is created by incorporating the offset cutting wheel assembly 650 with a single or multiple piece molded design as a means of control structure 760 in which at least one first portion serves as the head 761a and a second portion serves as a handle 761b and in some configurations, the handle 761b serves as a storage compartment where at least two halves could be separated and joined at will via any conventional means, such as but not limited to, snap-fit, mechanical fastener(s), or hinged with catch(es). The offset cutting wheel assembly 650 would be mounted to the head 761a portion via a shoulder axle 770 which is self-aligning and would allow the assembly 650 components to spin freely, yet remain centered on the shoulder axle 770, and true to the axis of rotation. A relief 762 is formed into the bottom of the handle in order to accommodate cutting wheel assembly 650. It should be understood, that while the offset cutting wheel assembly 650 is used in this example, any cutting wheel assembly, such as center cutting wheel assembly 600 in FIG. 10, could be used in its place. Graphics slitting device 750 is designed for gaps and channels which create straight paths and relaxed curves. An example of the type of application this graphics slitting device 750 might be used, see FIG. 14A which demonstrates the use of an advanced version of a graphics slitting device 800.

Referring now to FIGS. 14A-14C in which like elements are provided having like reference designations throughout the three views, new and useful embodiments of the present invention are described.

FIG. 14A illustrates how a graphics slitting device 800 of the present invention would be used in order to slit vinyl graphics 911 which is spanned across vehicle body panels 912a,b. In this example the graphics slitting device 800, using the center cut wedge shaped wheels 810a,b, is located near the bottom of, and centered between, the gap created by the two panels 912a,b, and the circular blade 820 is pushed through the vinyl graphics 911 until the inclined faces 811a,b of the center cut wedge shaped wheels 810a,b contact the vinyl covered edges of the panels 912a,b forming the gap. At this point, the graphics slitting device 800 is rolled along the gap in direction of travel DT10 in order to extend the cut to the bottom edge of the vinyl graphic while being careful not to cut into rocker panel 912. The graphics slitting device 800 is then rolled along the gap in direction of travel DT11 in order to extend the cut to the top edge of the vinyl graphic while being careful not to cut into any body parts near the top of the gap, thus completely separating the vinyl sheeting 911 bottom to top quickly and accurately.

FIG. 14B is a drawing of the graphics slitting device 800 of the present invention shown in the use position having its blade guard 880 retracted, thus causing approximately 60% of the cutting edge of the circular blade 820 to be completely exposed. The blade guard 880 is centrally located between the two center cut wedge shaped wheels 810a,b, and adjacent to the circular blade 820 and can be positioned on either side of said blade. Additional features shown herein are a control structure 830 comprising a head portion 837, a handle portion 838 and a storage portion 839. Other exterior appendages of the control structure 830 include grip treads 831a,b, at least one finger guard 832a,b located at the outermost edges of the head portion 837, and at least one eyelet 833 shown at the far end of the storage compartment 839. Positioning button 874 is also shown in the use position, while slot 835 allows the positioning button riser 873 to move forward and backward parallel with the length of the handle 838. Position lock ports 834a,b keep the blade guard shuttle locked in one of two positions, being either a use, or non-use position. In this embodiment of the present invention the control structure 830 could be comprised of at least two sections. In this case two sections 830a,b are split down the center lengthwise, top to bottom and the two halves 830a,b are secured together with a machine screw 885 which passes through clearance hole 836 and screws into a boss located inside 830b.

FIG. 14C is a drawing of the graphics slitting device 800 of the present invention shown inverted and in the non-use position having its blade guard 880 extended, thus causing 100% of the cutting edge of the circular blade 820 to be guarded. Safety lock button 877 is visible through safety lock port 844.

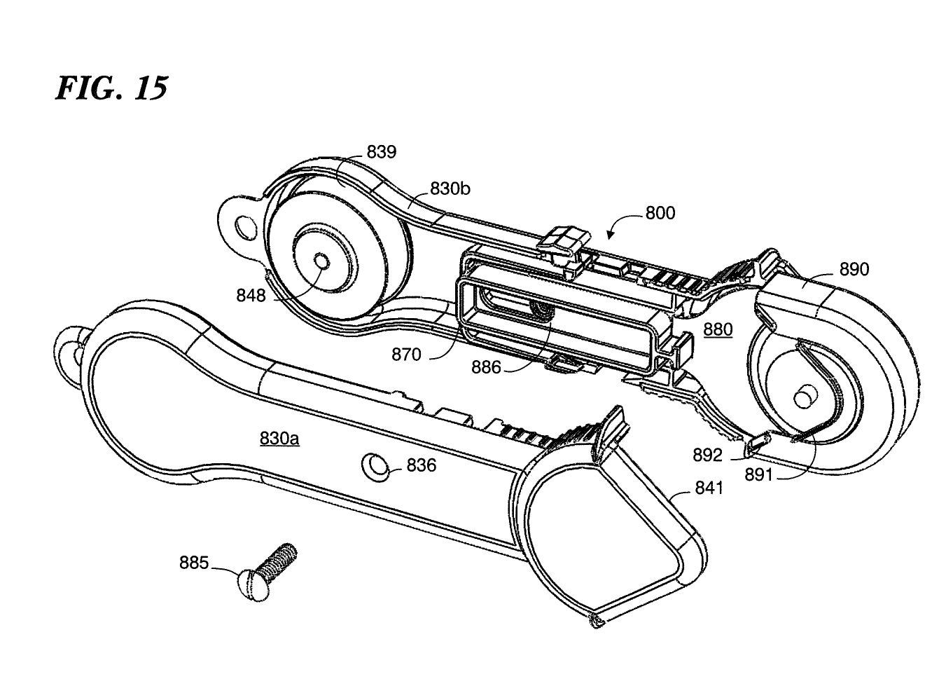

Referring now to FIG. 15 whereas the graphics slitting device 800 of the present invention is shown with one half of the control structure 830a attachably removed in addition to machine screw 886 which holds the two halves 830a,b together. In order to secure the two control structures 830a,b, they are placed together and at least one machine screw 885 is passed through at least one clearance hole 838 and is screwed into at least one threaded insert 886 centrally located on control structure 830b. It should be understood that while a machine screw 886 is used to join two control structures 830a,b together, any conventional means, such as but not limited to a snap-fit could be used as an alternative to, or in conjunction with, said machine screw 885. The storage portion 839 of control structure 830 is shown with spare parts stacked on its centering boss 848. Blade guard shuttle 870 is shown centrally located within the handle portion 838 of the control structure 830, and is also engaged with blade guard 880. A blade and wheel cover 890 is shown removably attached to the head portion 837 of the control structure 830, in which at least one blade and wheel cover flange 891 is designed to rest on the exterior surface of at least one lip 841, and at least one catch tab 892 is hooked around the inside surface of at least one lip 841. The blade and wheel cover 890 is designed to snap on to the control structure 830, as the catch tabs 892 are angled like a barb so they can easily snap into place behind lip 841, whereas the sides of the cover 890 must be squeezed inward in order for the catch tabs 892 to be pulled past the inside of lip 841 to release the cover 890.

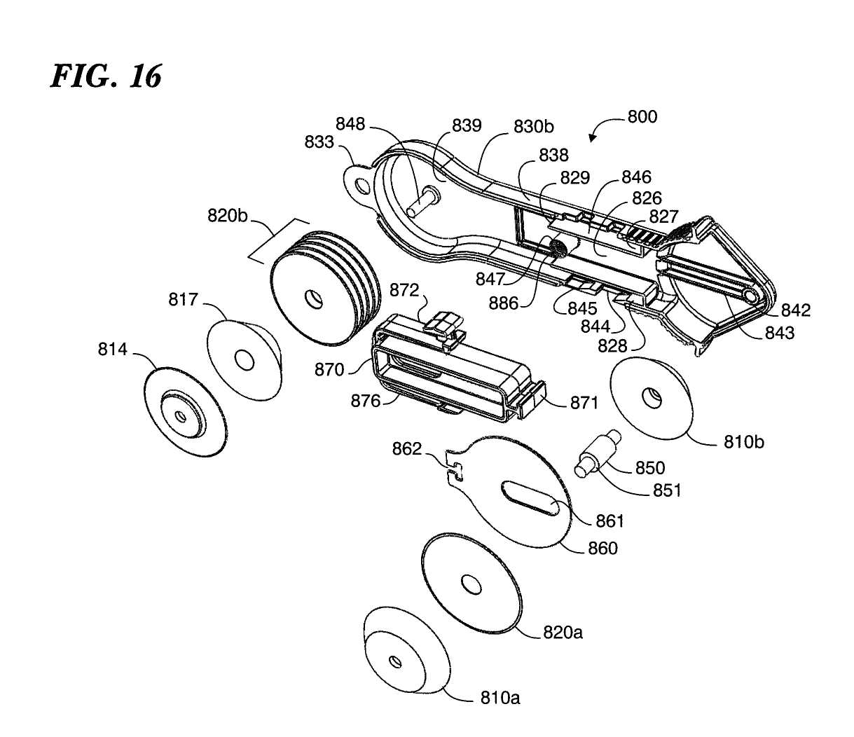

Referring now to FIG. 16 whereas the graphics slitting device 800 of the present invention is shown as an exploded view in which one half of the control structure 830a and the machine screw 885 of FIG. 15 have been hidden for ease of viewing the remaining internal structures.

The control structure 830b is shown having an axle support boss 842 located on the inside face and concentric with the rounded tip of the head portion 837, in addition to structural ribbing 843 which may be configured as required for a particular application. The shoulder axle 850 is inserted through centering wheel 810b so that the smaller diameter portion passes through the counter and center bores and into the axle support boss 842. Once the shoulder axle 850 and centering wheel 810b are in place, the blade guard 860 can be placed onto the shoulder axle 850 having it pass through the axle relief slot 861 so that it rests against the centering wheel 810b which allows the blade guard 860 to more back and forth freely along its designated path. T-bar relief 862 of blade guard 860 is designed to engage T-bar 871 of blade guard shuttle 870 in that when the blade guard shuttle 870 is moved back and forth along its prescribed path, blade guard 860 is moved with it. However, while the two components are locked together in a forward and back motion with respect the orientation of the handle portion 838, the blade guard 860 is also able to move laterally from side to side in order to accommodate the various lateral positions which the centering wheels 810a,b and offset wheels 814 and 817 may require. Next, the circular blade 820a is placed onto the shoulder axle 850 having it pass through its center bore until it rests against the blade guard 860.

It should be understood that the order of the two components, blade guard 860 and circular blade 820a, in which they have been assembled can be reversed as personal preference dictates. The second centering wheel 810a is then placed on the shoulder axle 850 so that the smaller diameter portion passes through the centering wheel's 810a counter and center bores, thus being able to be inserted into the other axle support boss 842 located on the other half of the control structure 830a (not shown) when assembled.

Further, an inner wall structure 846 in the shape of a “U” turned on its side is incorporated into the handle portion 838, having its ends terminate at the upper and lower outer walls of the handle portion 838, which creates three horizontal channels comprising, a larger main channel 826 centrally located which occupies approximately 75% of the handle's length starting from the front, in addition to two narrower channels, one narrower channel 827 directly above and one narrower channel 828 directly below the main channel 826. The main channel 826, is designed to house the blade guard shuttle 870 while allowing it to move forward and backward freely within said channel. A relief 829 is cut away from inner wall structure 846 in order to allow both the positioning 872 and safety lock 876 cantilevers to wrap around said inner wall structure 846 to the smaller channels 827 and 828 respectively.

At least one threaded insert boss 847 is centrally located inside the handle portion 838 of control structure 830b. In this embodiment of the present invention 800, a threaded insert 886 is shown permanently imbedded into the threaded insert boss 847 in a manner that allows machine screw 885 to be screwed into it as demonstrated in FIG. 15. Alternately, the insert 886 could be eliminated and the boss itself could be threaded, or any other conventional means could be used to mechanically join the two control structure halves 830a,b.

The storage portion 839 of control structure 830b has a centering boss 848 centrally located and protruding perpendicular from its inner face, having two separate diameters. Its purpose is to keep any stored parts organized and easily accessible. An eyelet 833 is formed at the outer edge of the storage portion of control structure 830b, but can be located wherever a particular application requires.

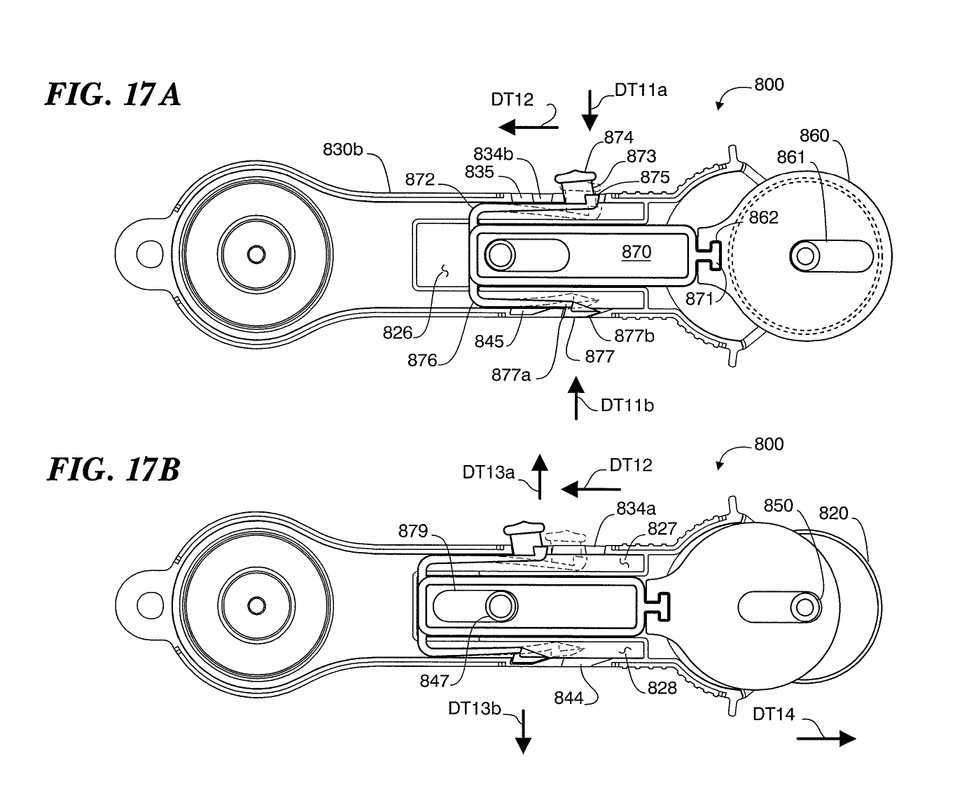

Referring now to FIGS. 17A and 17B in which like elements are provided having like reference designations throughout the two views illustrating the method in which the blade guard 860 is retracted to the use position and extended to the non-use position.

FIG. 17A demonstrates the first steps required in order to retract the blade guard 860 from the non-use position to the use position, in which the positioning button 874 is depress in DT11a (see dotted outline for new position) which disengages the positioning tab 875 from position lock port 834a. Simultaneously, safety lock button 877 must be depressed in DT11b (see dotted outline for new position) which disengages barb 877a from safety lock port 844 at which point the positioning button 874 can be slid horizontally in DT12 toward position lock port 834b as the button riser 873 passes travels along slot 835.

FIG. 17B demonstrates the second steps required in order to retract the blade guard 860 from the non-use position to the use position, in which the positioning button 874 and safety lock button 874 continues to travel in DT12 through the upper 827 and lower 828 channels (see dotted outlines) until the blade guard shuttle 870 stops and the positioning tab 875 pops up into position lock port 834a at which point safety lock button 877 drops down into safety lock well 846, at which point graphics slitting device 800 is ready to use. A boss relief 879 is formed into the mid wall of blade guard shuttle 8701n order to allow said shuttle to move freely, but also serves to stop said shuttle at the correct positions.

In order to extend and lock the blade guard back to the non-use position shown in FIG. 17A, only the positioning button 874 need be depressed because the leading edge 877a of the safety lock button 877 is angled up like a ski, allowing it to move forward in DT14 without catching on anything that would inhibit its forward movement. When the positioning button 874 is slid fully forward in DT14 both the positioning tab 876 and safety lock button 877 will snap into their respective ports, thus locking the blade guard in the safe non-use position.

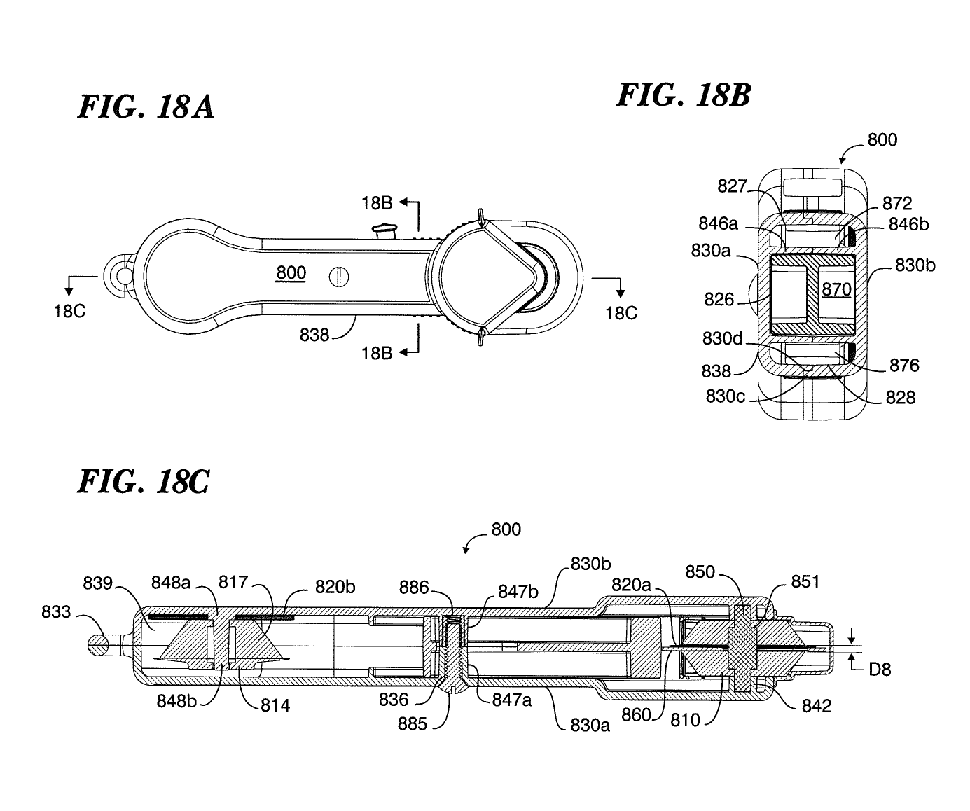

Referring now to FIGS. 18A-18C in which like elements are provided having like reference designations throughout the several views, a manually controlled graphics slitting device 800 used to separate sections of vehicle graphics is pictured in FIG. 18A as a sectional view reference in that sectional view 18B-18B is seen from the forward end of the handle portion 838 looking toward the rear of the device, and sectional view 18C-18C is from the mid horizontal plane looking downward from above.

FIG. 186 corresponds with sectional view 18B-18B in FIG. 18A of vehicle graphics slitting device 800 in order to illustrate how shuttle enclosure wall 846a,b, combined with the outside walls of control structures 830a,b, are used to create an enclosed main central channel 826 which houses the blade guard shuttle 870, allowing it to only move forward and backwards in relation to the length of the handle portion 838 of control structure 830a,b, in addition to two smaller upper and lower channels 827 and 828 which are designed to house the positioning cantilever structures 872 and 876 respectively.

In addition, at least one outer lip 830c is integrally formed along the edges of control structure 830b in order to help align and secure it to control structure 830a where at least one mating lip relief 830d is formed.

FIG. 18C corresponds with sectional view 18C-18C in FIG. 18A of graphics slitting device 800 in order to illustrate how the shoulder axle 850 which is seated into axle support boss 842, is designed to support and keep the two centering wheel structures 810 separated from each other, illustrated by dimension D8, with its shoulders 851, so as not allow them to bind on the blade 820 and the blade guard 860 as they rotate.

Additionally, the joining means is shown wherein clearance hole 836, and boss 847a through which it passes, are integrally formed centrally into the side faces of control structure 830a allowing fastener 885 to pass through and engage threaded insert 886 which is permanently disposed inside threaded insert boss 847b which in turn is integrally formed centrally into the inside face of control structure 830b.

Further, a centering boss 848a,b is shown having a first wider diameter base 848a which is designed to pass through the center bores of spare circular blades 820b, and a narrower and longer portion 848b is designed to accommodate the smaller center bore of the of the centering wheels 810a,b and offset wheels 814 and 817, in order to keep them organized inside said storage portion 839 of control structure 830a,b.

While the centering wheels 810a,b and offset wheels 814 and 817 are shown as solid, they could alternately be shelled with internal structural ribbing and hubs.

An eyelet 833 is integrally formed at the outer edge of the storage portion of control structure 830a,b, but can be located wherever a particular application requires.

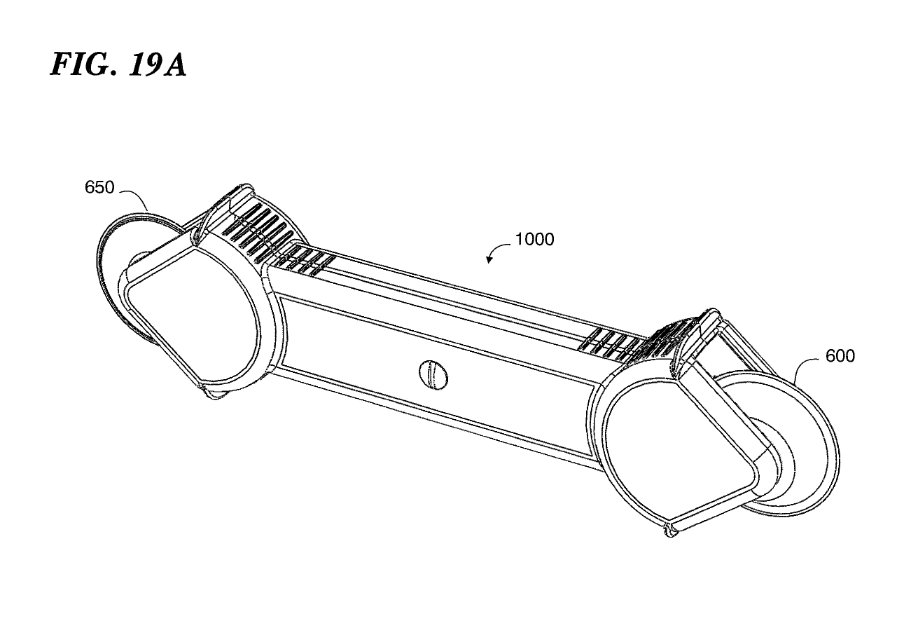

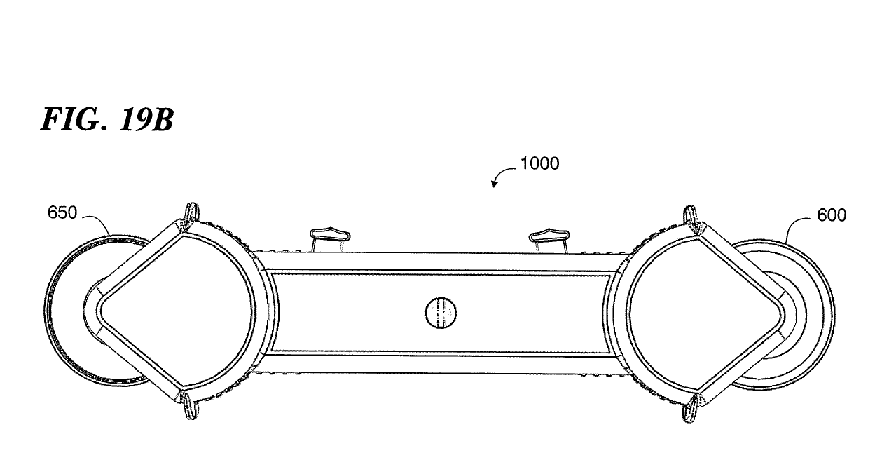

Referring now to FIGS. 19A and 19B in which like elements are provided having like reference designations throughout the several views, a graphics slitting device 1000 which may correspond to a vehicle graphics slitting device, for example, includes a pair of head sections each comprising a respective one of slitting structures 600, 660. In this exemplary embodiment, slitting structures 600, 650 are provided as cutting wheel assemblies. In one embodiment, one of the wheels 600, 650 may be provided as a so-called centering wheel and the other one of the wheels 600, 650 may be provided as a so-called offset wheel. Exemplary centering and offset wheels are described hereinabove. As shown, each end of each of graphics slitting device can optionally include blade guard structures, blade guard shuttle structures and other associated safety features all of which are described above in conjunction with at least FIGS. 14A-18C. The slitting structures 600, 650 are incorporated into both ends of the device facing opposite directions. The handle portion of device 1000 may optionally be lengthened to accommodate the dual slitting structures 600, 650 and the various safety features described herein.

One of ordinary skill in the art will appreciate further features and advantages of the concepts, structures and methods described herein based upon the above described embodiments. Accordingly, the concepts, structures and methods described herein should not to be limited by what has been particularly shown and described, except as indicated by appended claims. All the publications and references cited herein are expressly incorporated herein in their entirety.

What is claimed is:

1. A graphics cutting device for slitting graphics, the graphics cutting device comprising:
a control structure;
a guide structure, having a wedge-shaped profile in the form of one or more of a circular wedge structure; a linear wedge structure; or a conical shaped structure; and
a slitting structure suitable for cutting graphics, said slitting structure having a cutting edge, said slitting structure mounted to at least one of said control structure or said guide structure.

2. The graphics cutting device of claim 1 wherein said control structure is integrally formed with one of: said slitting structure; or said guide structure.

3. The graphics cutting device of claim 1 wherein said guide structure is a first one of a plurality of guide structures.

4. The graphics cutting device of claim wherein said guide structure comprises one or more wedge-shape surfaces.

5. The graphics cutting device of claim 4 wherein said wedge-shaped surface is provided as a circular wedge-shaped surface.

6. The graphics cutting device of claim 1, wherein:
said guide structure is provided as a circular, wedge-shaped guide structure corresponding to a surface of the graphics cutting device and integrally formed with said control structure; and
said control structure is provided on a surface of said guide structure opposite the surface on which said guide structure is disposed.

7. The graphics cutting device of claim 1 wherein said control structure is provided having a cavity formed therein, the cavity having a size and shape selected to accommodate a slitting structure.

8. The graphics cutting device of claim 1 wherein the cavity is oriented such that a cutting edge of said slitting structure blade is positioned forward of said guiding structure.

9. The graphics cutting device of claim 1 wherein said guide structure is provided as a wedge shaped wheel.

10. The graphics cutting device of claim 1 wherein said slitting structure is provided as a wheel having a cutting edge provided around a circumference of said wheel.

11. The graphics cutting device of claim 1 wherein said guide structure and said cutting structure are integrally formed as a wheel coupled to said control structure, said wheel having a wedge shape and having a cutting edge provided around a circumference thereof wherein the cutting edge is suitable for cutting graphics.

12. The graphics cutting device of claim 11 further comprising axle pins coupled to said control structure and to said wedge shaped wheel such that said wedge shape wheel can freely rotate.

13. The graphics cutting device of claim 12, wherein:
said control structure is shelled and made of two removably coupled halves separated lengthwise from top to bottom; and
said guide structure axle pins are held in place when the graphics cutting device is assembled by axle bosses formed within the wheel reliefs thereby allowing said wedge shaped wheels to freely rotate.

14. The graphics cutting device of claim 1 wherein said guide structure is provided from a wheel having at least one chamfered sides, with a center bore that is designed to accept an axle, while allowing the wheel to freely rotate about the axle.

15. The graphics cutting device of claim 14 wherein said wheel is provided having a pair of symmetrical chamfered sides suitable for keeping cutting device centered in a gap between surfaces of adjacent objects.

16. The graphics cutting device of claim 14 wherein said wheel is provided having a first chamfered side and a second side having a shape which is not symmetric with respect to the first chamfered side such that the asymmetrical sides are suitable to provide an offset cutting structure in order to make an offset cut in a gap between surfaces of adjacent objects.

17. The graphics cutting device of claim 14 wherein the at least one chamfered side of the guide structure is provided having one of: a concave shape; or a convex shape around its circumference.

18. The graphics cutting device of claim 14 further comprising two guide wheels combined with a cutting structure in the form of a circular blade having an outer diameter which is larger than a diameter the guide wheel structures.

19. The graphics cutting device of claim 1 further comprising a pair of head sections each head section provided at an opposing end of said control structure and each head section comprising a respective slitting structure such that the graphics cutting device is provided having a pair of slitting structures.

20. The graphics cutting device of claim 19 wherein each of said pair of slitting structures is provided as a cutting wheel assembly with a first one of the cutting wheel assemblies corresponding to a centering wheel and the other one of the cutting wheel assemblies corresponding to an offset wheel.
